(19) United States
(12) Patent Application Publication
(10) Pub. No.: US 2008/0085695 A1
(43) Pub. Date: Apr. 10, 2008

(54) Emergency Alert and Delivery Framework for Broadcast Systems

(75) Inventors: Jani Vare, Kaarina (FI); Jyrki Alamaunu, Turku (FI); Tommi Auranen, Turku (FI); Harri J. Pekonen, Raisio (FI); Reino Juhani Hiltunen, Merimasku (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/548,147

(22) Filed: Oct. 10, 2006

(51) Int. Cl. H04M 11/04

(52) U.S. Cl. 455/404.1

(57) ABSTRACT

Provided are apparatuses and methods for efficient and timely broadcasting of emergency information over any system by at least one transport protocol supported within each system, e.g., in DVB-H it is carried as an IP stream or as filecast, and within other DVB systems, can be supported as audio, video, or data and even as IP. Systems and methods are provided by which urgent emergency information or other information that needs immediate action(s) can be signaled to an end user.

### TECHNICAL FIELD

Aspects of the invention relate generally to broadcast systems. More specifically, aspects of the invention relate to emergency alert and delivery framework for broadcast systems.

### BACKGROUND

Digital broadband broadcast networks enable end users to receive digital content including video, audio, data, and so forth. End users may receive program or service information such as a broadcast program in a data stream via an IP Datacast (IPDC) over a broadcast network, for example. In addition, IP Datacast also defines an Electronic Service Guide (ESG) which is used to provide information to the user.

In IP Datacast, two different types of services for content delivery are specified: streaming and file delivery. The streaming service is based on RTP/RTCP as the streaming protocol. The file delivery service is based on FLUTE as the file delivery protocol.

A DVB-H network may carry multiple transport streams. Each transport stream carries a multiplex of DVB services. A multiplex may be defined by the ID of the network of origin and the carrying transport stream ID. A DVB service is composed of components, each of which is transported in an Elementary Stream (ES). A service component is identified by the service ID and a PID or alternatively by the sources and destination IP addresses of the corresponding IP streams.

In systems such as DVB-H there are no defined specific triggering mechanisms and apparatus for the broadcasting of emergency information, such as a natural disaster (e.g., a tsunami, tornado, hurricane, flooding) or man-made disasters (e.g., a terrorist attack, fire).

Hence, there is a need for efficient and effective methods and systems for providing the broadcasting of emergency information on systems such as DVB-H.

### BRIEF SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In an aspect of the invention, a method and apparatus is provided for efficient and timely broadcasting of emergency information over any system by at least one transport protocol supported within each system, e.g., in DVB-H it is carried as an IP stream or as filecast. Within other DVB systems it may be supported as audio, video, or data and even as IP.

In an aspect of the invention, a system and method are provided by which urgent emergency information or other information that needs immediate action(s) may be signaled to the end user.

In an aspect of the invention, triggering mechanisms are provided on different layers, such as layers according to the OSI layer architecture, e.g., physical layer (L1) in TPS bits, data link layer (L2) (i.e., transport stream adaptation field, PSI/SI and ULE), network layer (L3) (i.e., IPv6 extension header), and application layer (L7) (i.e., ESQ).

In an aspect of the invention, signaling of the emergency presence and/or PID information within a Transport Stream (TS) adaptation header is provided. In an aspect of the invention, apparatus is provided to provide the signaling of the emergency presence and/or PID information within a TS adaptation header.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an example of a wireless communication system in which one Embodiment 1 may be implemented in accordance with an aspect of the invention.

FIG. 2 illustrates an example of a wireless communication system in which one Embodiment 2 may be implemented in accordance with an aspect of the invention.

FIG. 3 illustrates an example of a procedure in accordance with the embodiment shown in FIG. 2.

FIG. 4 illustrates an example of a wireless communication system in which one Embodiment 3 may be implemented in accordance with an aspect of the invention.

FIG. 5 illustrates an example of a procedure in accordance with the embodiment shown in FIG. 4.

FIG. 6 illustrates an example of a wireless communication system in which one Embodiment 4 may be implemented in accordance with an aspect of the invention.

FIG. 7A and FIG. 7B illustrates examples of procedures in accordance with the embodiment shown in FIG. 6.

FIG. 8 illustrates an example of a wireless communication system in which one Embodiment 5 may be implemented in accordance with an aspect of the invention.

FIG. 9 illustrates an example of a procedure in accordance with the embodiment shown in FIG. 8 in accordance with an aspect of the invention.

FIG. 10 illustrates an example of a wireless communication system in which one Embodiment 6 may be implemented in accordance with an aspect of the invention

FIG. 11 illustrates an example of a procedure in accordance with the embodiment shown in FIG. 10.

FIG. 12 illustrates a generic structure of a notification protocol in accordance with at least one aspect of the invention.

FIG. 13 illustrates a payload direct message in the form of a delivery system type and PID in accordance with at least one aspect of the invention.

FIG. 14 illustrates a procedure for accessing notification information in accordance with at least one aspect of the invention.

FIG. 15 illustrates a ULE extension header with time notification protocol and NPA Address in accordance with an aspect of the invention.

FIG. 16 illustrates a ULE extension header with time notification protocol without NPA Address in accordance with an aspect of the invention.

FIG. 17 illustrates a ULE extension header with notification protocol and NPA Address in accordance with an aspect of the invention.

FIG. 18 illustrates a ULE extension header payload with notification protocol without NPA Address in accordance with an aspect of the invention.

FIG. 19 illustrates a ULE extension header payload with notification protocol in accordance with an aspect of the invention.

FIG. 20 illustrates a ULE extension header payload with notification protocol in accordance with an aspect of the invention.

FIG. 21 illustrates notification information in accordance with an aspect of the invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

It is noted that various connections are set forth between elements in the following description. It is noted that these connections in general and, unless specified otherwise, may be direct or indirect and that this specification is not intended to be limiting in this respect.

In accordance with one aspect of the invention, signaling of emergency presence and/or PID information within a TS adaptation header is provided. For example, signaling may be accomplished with a specific version number of INT table and usage of a fixed IP address and port.

In accordance with another aspect of the invention, signaling of emergency presence is provided by setting the current_next_indicator to value ‘0’ or ‘1’ in PAT to indicate that there is emergency information present with fixed PID value.

In accordance with yet another aspect of the invention, signaling of emergency information may be incorporated into any wireless system, such as a wireless system that provides high quality multimedia (e.g., audio and video), to wireless terminals. Within all systems which support IP, the emergency information may be carried within at least one IP stream.

### Embodiment 1

In accordance with one embodiment, an emergency alert method comprises a forced emergency alert service wherein all content within a transmitter is replaced with emergency information. This method may be applied to any bearer and in maximum to all transmission protocols supported by the bearer. One such method, called the “Emergency Alert System” (EAS) is in use in the United States and is described in FCC 47 CFR part 11, which is incorporated herein by reference.

### Embodiment 2

In accordance with one embodiment, a static emergency service may be provided wherein service may also be available for carrying emergency information when needed. In this embodiment, a IP address and PID may vary between different networks and even between different transport streams within a network. However, when allocated for each TS, the interval (t) between emergency information messages remains static or only PID may change. The receiver can monitor this service with implementation specific intervals (t) and receive emergency service when transmitted within that PID.

### Embodiment 3

In accordance with one embodiment, an emergency alert triggering may be provided using a version number in of PSI/SI (Program Specific Information/Service Information) tables. In this embodiment, a method is provided that can be supported by all systems that use PSI/SI tables or substantially similar tables, such as in ATSC or in DAB systems. In a “DVB specific” implementation, for example, an INT version number may be set to a specific value that indicates that there is emergency information available. Such a version number may be, for example, decimal 31. Another possible implementation could be the setting of current_next_indicator value to ‘0’ or ‘1’ in PAT to indicate that emergency information is available within current transport stream. Such emergency message could in addition be signalled always with a well defined IP address and port and PID. In systems supporting some other IP, other adaptations may be used.

### Embodiment 4

In accordance with an embodiment, an emergency alert triggering and/or service discovery information signalling with a TS adaptation field may be provided. In this embodiment, a method is provided that may be supported by all systems which support transport stream format. Such systems may include e.g. DVB and ATSC systems. For this approach there may be several different variations. First, it could be mandated, for example in future DVB-H systems, that an adaptation field is not to be supported except in case of emergency signalling. In such case, a receiver may need to be able to discover that emergency information is available. The emergency information itself may be included within an adaptation field itself. The adaptation field may include some or all of the following: IP address, PID, port, description of the emergency service and other possible information, such as codecs to be used. In case only PID is signalled within adaptation field, an IP address and/or port could be well-defined, and codec information etc. static, thereby allowing immediate reception of the emergency information. A similar approach may be taken by using “reserved future bits” “00” to indicate that a particular adaptation field carries emergency information and/or signalling information for it (see above).

### Embodiment 5

In one embodiment, an emergency alert triggering and/or information signalling within a ULE extension header is provided. This method is similar to the emergency alert triggering and/or service discovery information signalling with TS adaptation field, identified above, except that a ULE extension header is used instead of an adaptation field. Also, in this method the emergency information is carried within extension header itself. ULE used herein is “Unidirectional Lightweight Encapsulation” as defined in RFC4326.

### Embodiment 6

In one embodiment, an emergency alert triggering and/or information signalling within an IPv6 extension header is provided. This method is similar to the emergency alert triggering and/or service discovery information signalling with TS adaptation field, identified above, except that an IPv6 extension header is used for this purpose. Similarly, as in ULE extension header embodiment identified above, the emergency message is carried within IPV6 extension header.

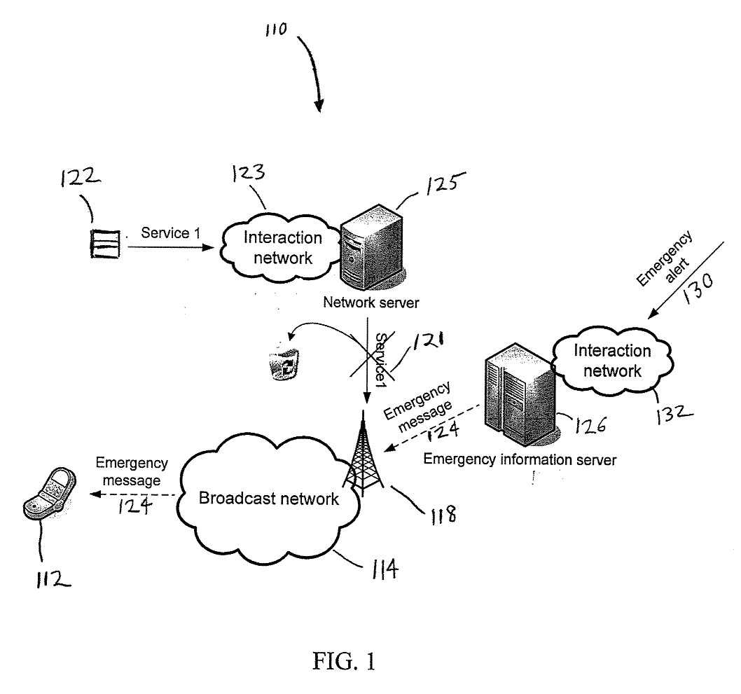

FIG. 1 illustrates an example of a wireless communication system 110 in which the systems and methods of the invention may be advantageously employed. Wireless communication system 110 is particularly suitable for Embodiment 1 described above, i.e., the insertion of emergency information comprising a forced emergency alert service wherein all content within a transmitter may be replaced with emergency information. One or more network-enabled mobile devices 112, such as a personal digital assistant (PDA), cellular telephone, mobile terminal, personal video recorder, portable or fixed television, personal computer, digital camera, digital camcorder, portable audio device, portable or fixed analog or digital radio, or combinations thereof, are in communication with a service source 122 through a broadcast network 114. The mobile terminal/device 112 may comprise a digital broadcast receiver device and receive service 1 from service source 122 via broadcast network 114. The service source 122 may be connected to several service providers that may provide their actual program content or information or description of their services and programs to the service source that further provides the content or information to the mobile device 112. The several service providers may include but are not limited to one or more television and/or digital television service providers, analog and/or digital AM/FM radio service providers, SMS/MMS push service providers, Internet content or access providers. As shown in FIG. 1, service 1 is outputted from service source 122 and is inputted via interaction network 123 to network server 125.

The broadcast network 114 may include a radio transmission of IP datacasting over DVB and/or DVB-H. The broadcast network 114 may broadcast a service 1 such as a digital or analog television signal and supplemental content related to the service via transmitter 118. The broadcast network 114 may also include a radio, television or IP datacasting broadcasting network. The broadcast network 114 may also transmit supplemental content, which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through a cellular network (not shown).

According to this embodiment, an end user consumes services in a normal manner. In the case of an emergency, however, an emergency alert 130 may be provided via an interaction network 132 to emergency information server 126. Emergency message 124 may be outputted from emergency information server 126 and may replace all services, including service 1, to user device 112 via transmitter 118. For example, as shown by “X” 121 in FIG. 1, service 1 may be replaced by emergency message 124 when emergency message 124 is provided to transmitter 118. Services, including but not limited to service 1 and emergency message 124, may be made available to user device 112 via broadcast network 114, or a cellular network (not shown). The cellular network may include a wireless network and a base transceiver station transmitter (not shown). The cellular network may include a second/third-generation (2G/3G) cellular data communications network, a Global System for Mobile communications network (GSM), or other wireless communication network such as a WLAN network.

In one aspect of the invention, mobile device 112 may include a wireless interface configured to send and/or receive digital wireless communications within the cellular network. The information received by mobile device 112 through the cellular network (not shown) or broadcast network 114 may include user selection, applications, services, electronic images, audio clips, video clips, and/or WTAI (Wireless Telephony Application Interface) messages. As part of cellular network, one or more base stations (not shown) may support digital communications with receiver device 112 while the receiver device is located within the administrative domain of the cellular network.

Examples of other digital broadcast standards which digital broadband broadcast system 110 may utilize include Digital Video Broadcast—Terrestrial (DVB-T), Integrated Services Digital Broadcasting—Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Forward Link Only (FLO), Digital Audio Broadcasting (DAB), and Digital Radio Mondiale (DRM). Other digital broadcasting standards and techniques, now known or later developed, may also be used. An aspect of the invention is also applicable to other multicarrier digital broadcast systems such as, for example, T-DAB, T/S-DMB, ISDB-T, and ATSC, proprietary systems such as Qualcomm MediaFLO/FLO, and non-traditional systems such 3GPP MBMS (Multimedia Broadcast/Multicast Services) and 3GPP2 BCMCS (Broadcast/Multicast Service).

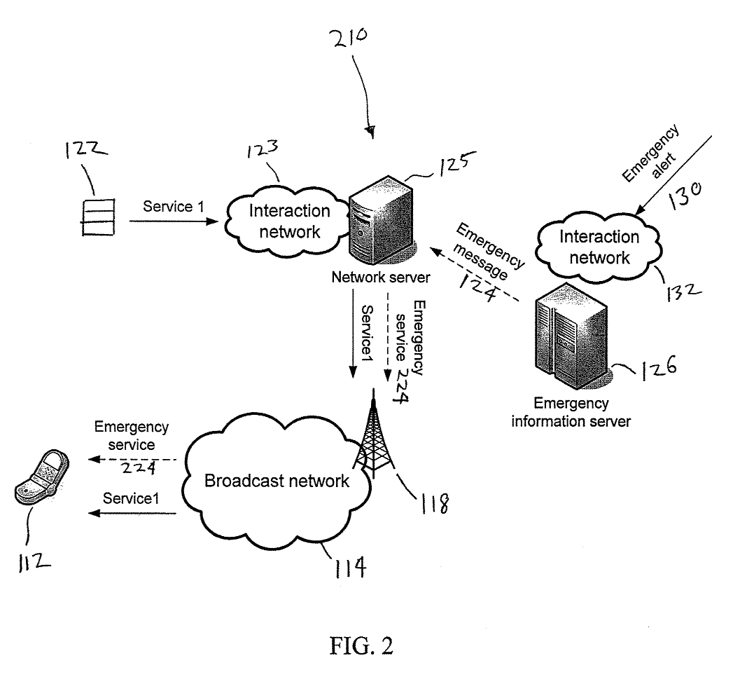

FIG. 2 illustrates an example of a wireless communication system 210 in which the systems and methods of the invention may be advantageously employed. Wireless communication system 210 may be particularly suitable for Embodiment 2 described above, i.e., static emergency service where service is available for carrying emergency information when needed. FIG. 2 is similar to FIG. 1, with the exception that emergency information server 126 sends an emergency message 124 to network server 125, emergency service 224 is provided along with service 1 to user device 112 via transmitter 118 and network 114. Emergency service 224 can comprise a bottom screen panel at the bottom of a display screen of user device 112.

According to this embodiment, user device 112 may discover the access information for the specific emergency service 224 by means in accordance with DVB-H and IPDC over DVB-H standards. However, such service contains emergency information when an emergency or potential emergency situation occurs.

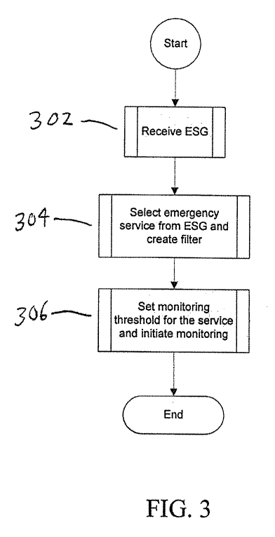

FIG. 3 illustrates an exemplary implementation for the user device 112 in discovering emergency information in the embodiment shown in FIG. 2. The monitoring threshold may be a fixed predetermined time interval set by the network operator or it may be signalled in the ESG. In one embodiment, the user may be allowed to modify it within specified limits. The user might wish to shorten the interval when an emergency situation is detected and lengthen it when an emergency situation is not expected. The user may not, however, be allowed to lengthen it beyond a maximum value, which may be announced by the network operator or by authorities.

As shown in FIG. 3, in step 302, ESG may be received. In step 304, an emergency service is selected from the ESG and a filter is created. Depending on the network operator and/or location, the number of different emergency service types may vary. Respectively, different emergency alerts may use the same “channel.” In step 306, the monitoring threshold is set for the service, and monitoring may be initiated in accordance with the set monitoring threshold. The set monitoring threshold may be set between 0 and n seconds, with n being the maximum value allowed by the system.

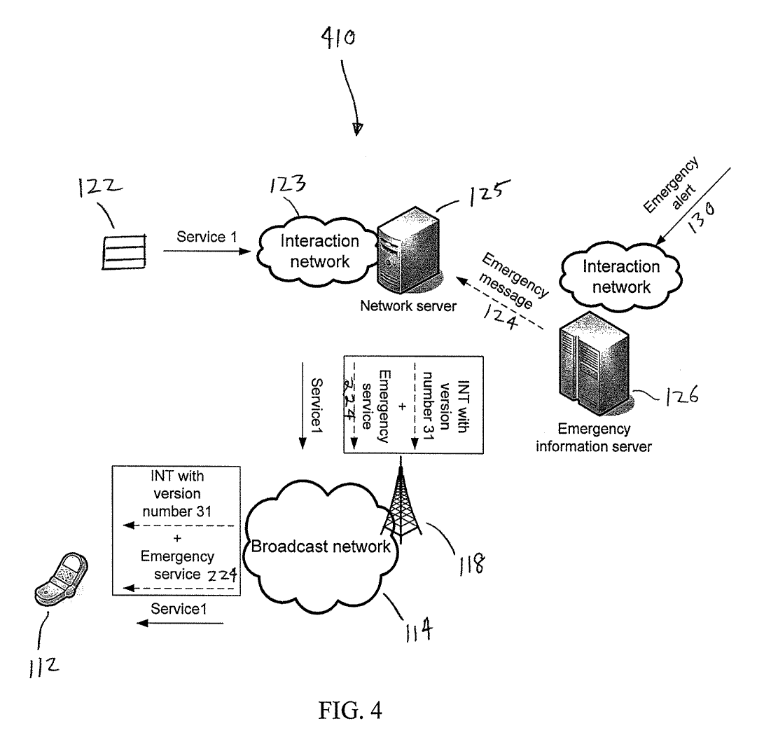

FIG. 4 illustrates an example of a wireless communication system 410 in which the systems and methods of the invention may be advantageously employed. Wireless communication system 410 may be particularly suitable for Embodiment 3 described above, i.e., emergency alert triggering by using a version number in PSI/SI. FIG. 4 is the same as FIG. 2, with the exception that a user device 112 is able to detect the availability of emergency service based on the version number of a PSI/SI table, e.g., INT. FIG. 4 illustrates an example where version number 31 may be used within INT for the latter purpose.

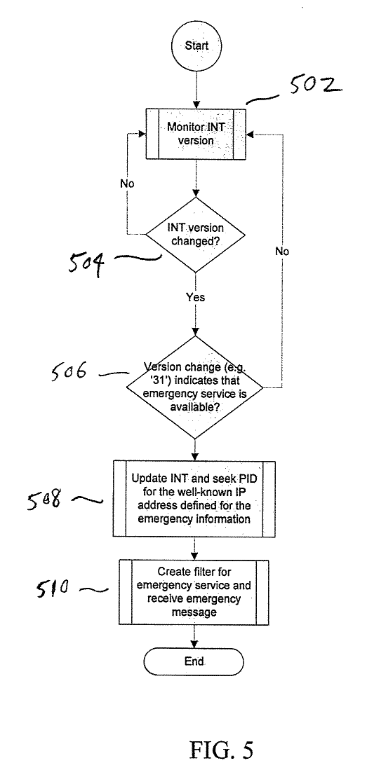

FIG. 5 illustrates an exemplary implementation for the user device 112 in discovering emergency information in the embodiment shown in FIG. 4. The version number 31 used may be expressed with five (5) bits as in the standard.

As shown in FIG. 5, in step 502, the monitoring of the INT version takes place. In step 504, it may be determined whether the INT version has changed. If answer in step 504 is “no”, then there is a return to step 502. If answer in step 504 is “yes”, then the next step that may be performed is step 506. In step 506, it may determine whether the version change (e.g., “31”) indicates that emergency service is available.

If answer in step 506 is “no”, then there is a return to step 502. If answer in step 506 is “yes”, then the next step is step 508. In step 508, an update is made of INT and seek PID for the well-known IP address defined for the emergency information. In step 510, a filter is created for emergency serviced and for receiving emergency messages.

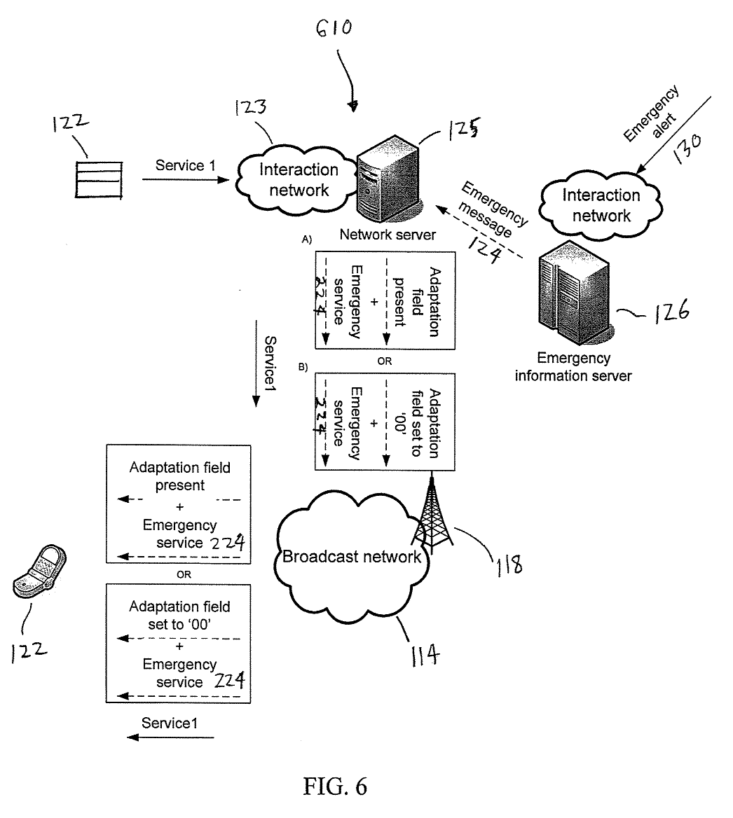

FIG. 6 illustrates an example of a wireless communication system 610 in which the systems and methods of the invention may be advantageously employed. Wireless communication system 610 may be particularly suitable for Embodiment 4 described above, i.e., emergency alert triggering and/or service discovery information signaling with TS adaptation field. FIG. 6 is similar to FIG. 4, with the exception that system 610 may use an adaptation field to signal either presence of emergency information and/or service discovery information as well, respectively A) and B), instead of an INT with version number 31.

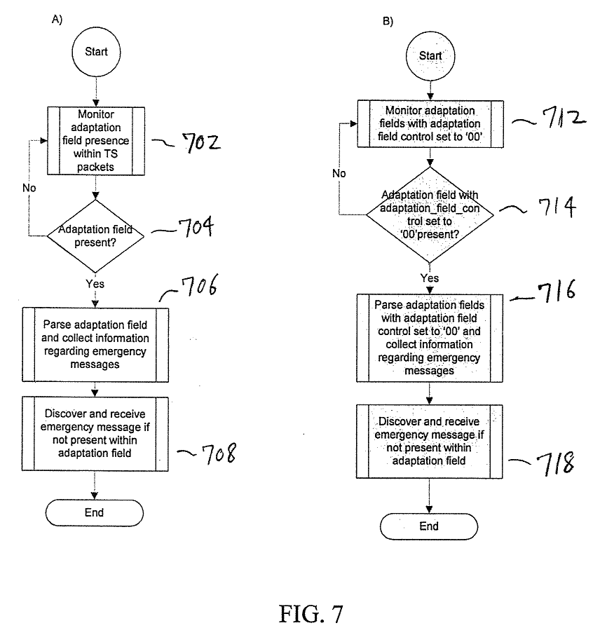

FIGS. 7A and 7B illustrate exemplary implementations for the user device 112 in discovering emergency information in the embodiment shown in FIG. 6. As shown in FIG. 7A, in step 702, the monitoring of the adaptation field presence within TS packets takes place. In step 704, it is determined whether the adaptation field is present. If answer in step 704 is “no”, then there is a return to step 702. If the answer in step 704 is “yes”, then the next step is step 706. In step 706, there is a parsing of the adaptation field and collecting of information regarding emergency messages—this depends on the used variation, e.g., the adaptation field may contain a complete emergency message, only PID information, or PID and IP address and port information, etc. In step 708, the emergency message is discovered and received if not present within the adaptation field.

As shown in FIG. 7B, in step 712, the monitoring of the adaptation field with adaptation field control set to “00” takes place. In step 714, it is determined whether the adaptation field with adaptation_field_control is set to “00” present. If answer in step 714 is “no”, then there is a return to step 712. If the answer in step 714 is “yes”, then the next step is step 716. In step 716, there is a parsing of the adaptation fields with the adaptation field control set to “00” and collecting of information regarding emergency messages—this depends on the used variation, e.g., the adaptation field can contain a complete emergency message, only PID information, or PID and IP address and port information, etc. In step 718, the emergency message is discovered and received if not present within the adaptation field.

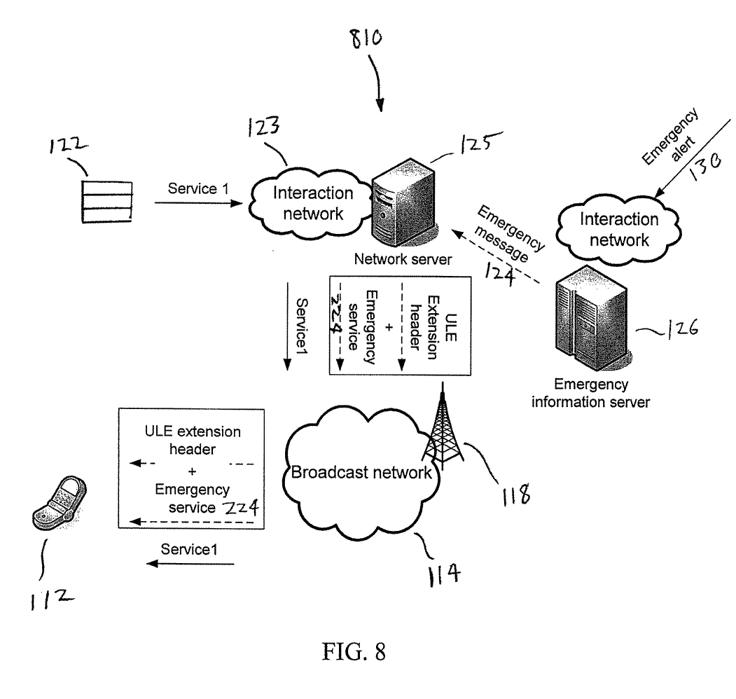

FIG. 8 illustrates an example of a wireless communication system 810 in which the systems and methods of the present invention may be advantageously employed. Wireless communication system 810 may be particularly suitable for Embodiment 5 described above, i.e., emergency alert triggering and/or information signaling with a ULE extension header. FIG. 8 may be similar to FIG. 4, with the exception that system 810 uses signaling with a ULE extension header, instead of an INT with version number.

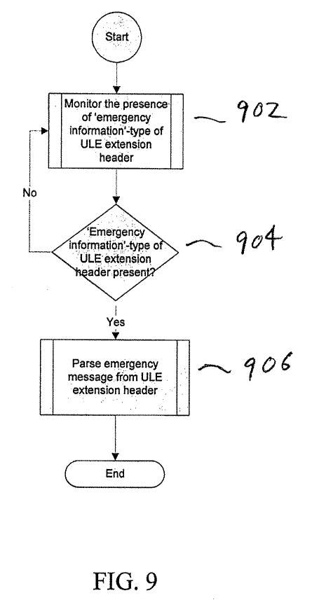

FIG. 9 illustrates an exemplary implementation for the user device 112 in discovering emergency information in the embodiment shown in FIG. 8.

As shown in FIG. 9, in step 902, the monitoring of the presence of emergency information-type of ULE extension header may take place. In step 904, it may be determined whether the emergency information-type of ULE extension header is present. If answer in step 904 is “no”, then there is a return to step 902. If the answer in step 904 is “yes”, then the next step is step 906. In step 906, there is a parsing of the emergency message from the ULE extension header.

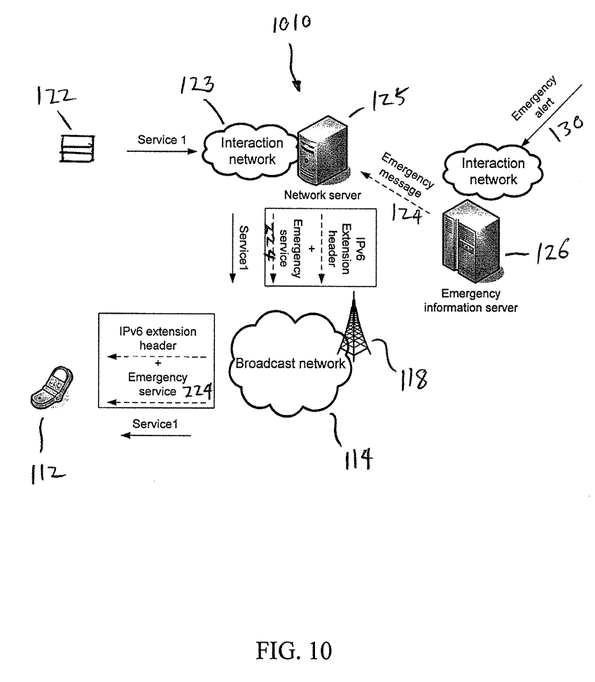

FIG. 10 illustrates an example of a wireless communication system 1010 in which the systems and methods of the present invention may be advantageously employed.

Wireless communication system 1010 may be particularly suitable for Embodiment 6 described above, i.e., emergency alert triggering and/or information signaling within an IPv6 extension header. FIG. 10 may be similar to FIG. 8, with the exception that system 1010 uses signaling with an IPv6 extension header, instead of a ULE extension header.

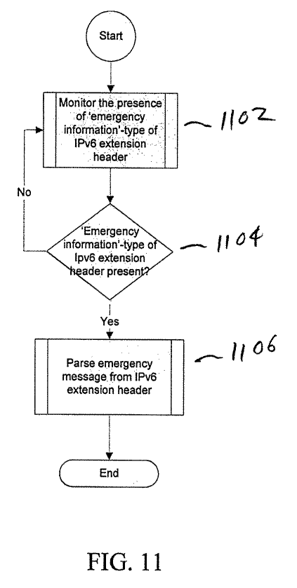

FIG. 11 illustrates an exemplary implementation for the user device 112 in discovering emergency information in the embodiment shown in FIG. 10.

As shown in FIG. 11, in step 1102, the monitoring of the presence of emergency information-type of IPv6 extension header takes place. In step 1104, it may be determined whether the emergency information-type of IPv6 extension header is present. If answer in step 1104 is “no”, then there is a return to step 1102. If the answer in step 1104 is “yes”, then the next step is step 1106. In step 1106, there is a parsing of the emergency message from the IPv6 extension header.

The emergency message itself may be in some embodiments the same as or substantially similar to the protocol that is being used for United States EAS messages carrying one or more of the following data items: a emergency message identification, an identification of the originator, type of the event, location for which the message is intended, and validity time for the message. The emergency message may, in addition, carry information on possible emergency transmissions which information can be used by the terminal for receiving additional information and/or contact persons, phone numbers, etc. The emergency message can be displayed on the display of the terminal and/or can be an audible signal overriding the content that the terminal is rendering and possibly modifying the terminal settings, e.g. for loudness, brightness, etc.

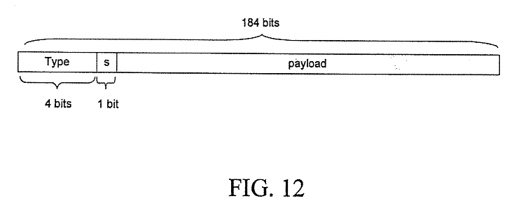

It is noted that in one embodiment, the notification protocol defined for the ISO/IEC 13818-1 may be applied when adaptation field control is set to “0”. This protocol may used in Embodiment 4 described above. FIG. 12 illustrates a generic structure of a notification protocol. The payload identified in FIG. 12 can comprise a direct message.

The 4 bit field can indicate the type of notification included within an adaptation field with values of the different notification types listed for purposes of example only in Table 1.

TABLE 1
Exemplary Notification Types

| type | value |
|---|---|
| emergency alert | 0000 |
| traffic announcement | 0001 |
| weather information | 0010 |
| system information | 0011 |
| reserved future use | 0100–1111 |

An s-bit or one bit field can indicate whether notification is signaled with “direct message”, i.e., as ASCII characters within the adaptation field payload of the current TS packet or whether the payload contains the “description” of the location of the notification message. Exemplary s-bit values are shown in Table 2.

TABLE 2
The s-bit values.

| description | s-bit value |
|---|---|
| Direct message | 0 |
| description | 1 |

It is noted that one TS may contain both signaling methods, i.e., “direct message” and the “description”, but these cannot co-exist within one TS packet.

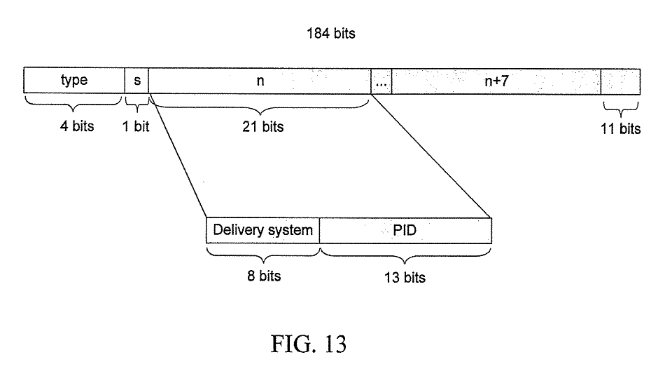

A payload can contain either the direct message as ASCII characters as illustrated in FIG. 12, or a delivery system type and PID, as illustrated in FIG. 13.

The allocation of delivery systems is listed in Table 3 by way of example.

| Delivery system | value |
|---|---|
| DVB-H | 00000000 |
| DVB-H2 | 00000001 |
| DVB-T DATA | 00000010 |
| DVB-T PES | 00000011 |
| DVB-C | 00000011 |
| DVB-S | 00000101 |
| DVB-S2 | 00000111 |
| ISDB-T | 00001000 |
| DMB | 00001001 |
| DAB | 00001010 |
| ATSC | 00001011 |
| reserved future use | 00001100–11111111 |

In the case of IP based services, the used IP address, port, codecs, etc. may be delivery system specific or can for example be defined globally.

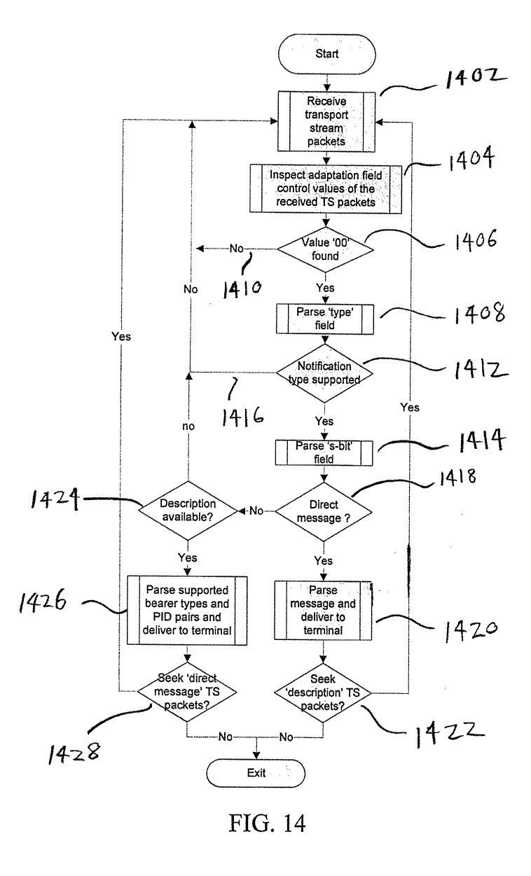

The procedure for accessing notification information is illustrated in FIG. 14. FIG. 14 is an example implementation of the receiver activity, including the step of inspecting adaptation field control values in received TS packets. Step 1402 comprises the step of receiving at a receiver transport stream packets via a network. Step 1404 comprises the step of inspecting adaptation field control values in received transport stream packets. Step 1406 comprises the step of determining whether a value of “00” is found in the received transport stream packets. Step 1408 comprises the step of parsing the type of field if a value of “00” is found in step 1406. Step 1410 comprises the step of returning to step 1402 if a value of “00” is not found in step 1406. Step 1412 comprises the step of determining whether the notification type is supported. The notification type is signaled, e.g., in adaptation field, and based on that the terminal can determine whether it supports each notification type or not. Step 1414 comprises the step of parsing the s-bit field if the notification type is found to be supported in step 1412. Step 1416 comprises the step of returning to step 1402 if the notification type is found not to be supported in step 1412. Step 1418 comprises the step of determining whether the message is a direct message in step after step 1414. Step 1420 comprises the step of parsing the message and delivering the message to a terminal if it is determined in step 1418 that the message is a direct message. In step 1420, in case of an emergency message, the receiver can be set into the mode where all other activity is halted and only the emergency message is delivered to the terminal. Step 1422 comprises the step of seeking description transport stream packets after step 1420. If it is determined in step 1418 that the message is not a direct message, then the next step can be step 1424. Step 1424 comprises the step of determining whether a description is available. If it is determined in step 1424 that a description is available, then the next step can be step 1426. Step 1426 comprises the step of parsing supported bearer types and PID pairs and delivering to a terminal. Step 1428, which follows step 1426, comprises the step of seeking direct message transport stream packets.

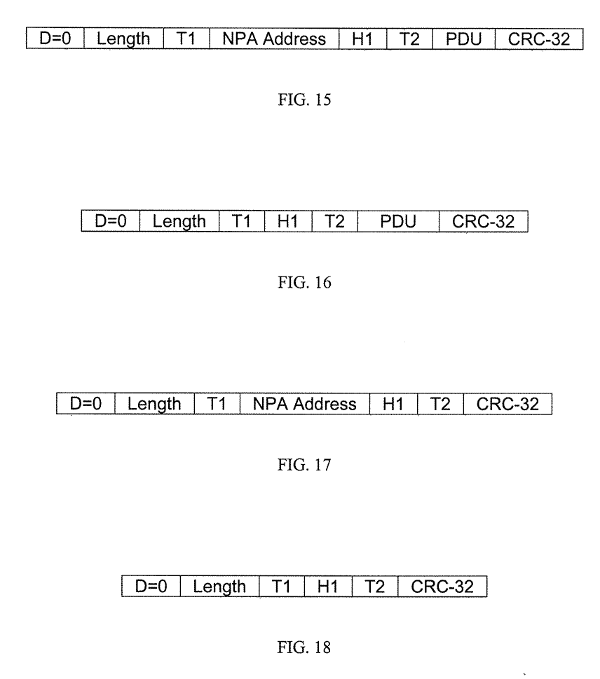

FIG. 15 illustrates a ULE extension header with time notification protocol and an NPA Address. This protocol may be used in Embodiment 5 described above. As shown in FIG. 15, the ULE extension header can comprise eight parts: D=0, Length, T1, Network Point of Attachment (NPA) Address, H1, T2, PDU, and CRC-32. T1 can indicate that the next header is an extension header with notification protocol. H1 can be the notification protocol. PDU can be a payload, e.g., IPv4 or IPv6 datagrams. An example of an NPA may be an IEEE medium Access Control CMAE address. Additional information can be found in accordance with RFC 4326.

FIG. 16 illustrates a ULE extension header with time notification protocol without an NPA Address. This protocol may be used in Embodiment 5 described above.

FIG. 16 is the same as FIG. 15, except there is no NPA Address. The ULE base header information can comprise D=0, Length, and T1. The extension header information can comprise H1 and T2.

FIG. 17 illustrates a ULE extension header with notification protocol and NPA Address. This protocol may be used in Embodiment 5 described above. FIG. 17 is the same as FIG. 15, except there is no PDU. The ULE base header information can comprise D=0, Length, and T1. The extension header information can comprise H1 and T2.

FIG. 18 illustrates a ULE extension header payload with notification protocol without NPA Address. This protocol may be used in Embodiment 5 described above. FIG. 18 is the same as FIG. 15, except there is no NPA Address and no PDU. The ULE base header information can comprise D=0, Length, and T1. The extension header information can comprise H1 and T2.

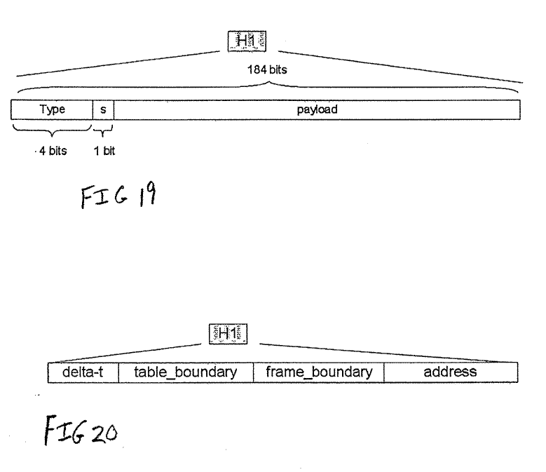

FIG. 19 illustrates a ULE extension header payload with notification protocol. This protocol may be used in Embodiment 5 described above. As shown in FIG. 19, H1 comprises three parts: Type, s, and payload. The three parts can comprise 184 bits total, with the Type part comprising 4 bits, and the s part comprising 1 bit.

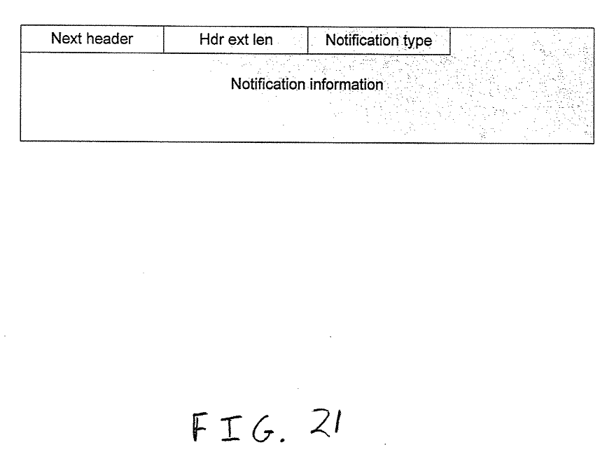

FIG. 20 illustrates a ULE extension header payload with notification protocol. This protocol may be used in Embodiment 5 described above. As shown in FIG. 19, H1 comprises four parts: delta-t, table_boundary, frame_boundary, and address.

FIG. 21 illustrates notification information in accordance with an embodiment of the invention. This protocol may be used in Embodiment 6 described above. Four parts are shown: Next header, Hdr ext len, Notification type, and Notification information.

The part identified as Next header can comprise an 8-bit selector that identifies the type of header immediately following the Notification header, and it may use the same values as the IPv4 Protocol field (e.g., RFC-1700 et seq.). The part identified as Hdr ext len can comprise an 8-bit unsigned integer, with a length of the Notification header in 8-octet units, not including the first 8 octets. The part identified as Notification type can comprise an 8-bit unsigned integer, and which indicates the type of notification in 8-octet units, not including the first 8 octets. The part identified as Notification protocol can comprise notification protocol syntax in accordance with the invention.

The embodiments herein include any feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques.

We claim:

1. A method comprising:
transmitting a non-emergency wireless service from a network server to a wireless device via a network; and
transmitting an emergency message from an emergency information server to the wireless device via the network, the emergency message corresponding to the emergency alert, wherein the emergency information server is different than the network server.

2. The method of claim 1, wherein when an emergency message is transmitted to the wireless device, the non-emergency wireless service from the network server ceases to be transmitted to the wireless device.

3. The method of claim 1, wherein the network is a broadcast network.

4. The method of claim 1, wherein the network is a cellular network.

5. The method of claim 1, wherein the non-emergency wireless service is a transport stream.

6. The method of claim 5, wherein the transport stream is a digital video broadcast transport stream.

7. The method of claim 5, wherein the transport stream is in DVB-H format.

8. The method of claim 1, wherein the emergency message is transmitted to the wireless device contemporaneously with the non-emergency wireless service.

9. A method comprising:
receiving in a wireless device a non-emergency wireless service from a network server, receiving in the wireless device an emergency alert from an emergency information server, the emergency information server different than the network server.

10. The method of claim 9, wherein when an emergency message is received by the wireless device the non-emergency wireless service from the network server ceases to be received by the wireless device.

11. The method of claim 9, wherein receiving in wireless device comprises receiving the non-emergency wireless service from a broadcast network.

12. The method of claim 9, wherein receiving in wireless device comprises receiving the non-emergency wireless service from a cellular network.

13. The method of claim 9, wherein the non-emergency wireless service is a transport stream.

14. The method of claim 13, wherein the transport stream is a digital video broadcast transport stream.

15. The method of claim 13, wherein the transport stream is in DVB-H format.

16. The method of claim 9, wherein the emergency message is received by the wireless device contemporaneously with the non-emergency wireless service.

17. The method of claim 9, further comprising receiving an electronic service guide, selecting emergency service from the electronic service guide and creating a filter, setting the monitoring threshold for the emergency service, and initiating the monitoring in the wireless device.

18. A method comprising:
transmitting a non-emergency wireless service from a network server to a wireless device via a network;
transmitting an emergency message from the emergency information server to the network server; and
transmitting emergency service from the network server to the wireless device via the network, the emergency service corresponding to the emergency message, the emergency message corresponding to the emergency alert.

19. The method of claim 18, wherein the emergency message is transmitted to the wireless device contemporaneously with the non-emergency wireless service.

20. The method of claim 18, further comprising emergency alert triggering by a current_next_indicator_value of PSI/SI

21. The method of claim 20, wherein the current_next-indicator_value of PSI/SI is the current_next_indicator_value of PAT.

22. The method of claim 21, wherein the current_next-indicator value is set either to ‘0’ or to ‘1’.

23. The method of claim 18, further comprising emergency alert triggering by a version number of PSI/SI.

24. The method of claim 23, wherein the version number of PSI/SI is INT version number.

25. The method of claim 24, further comprising monitoring the INT version, determining whether the INT version has changed, and if yes, determining whether the version change indicates that an emergency service is available.

26. The method of claim 25, further comprising updating INT and seeking PID for a predetermined IP address defined in the emergency information.

27. The method of claim 26, further comprising creating a filter for emergency service and receiving the emergency service in the wireless device.

28. The method of claim 18, further comprising emergency alert triggering by an adaptation field being present.

29. The method of claim 28, further comprising monitoring adaptation field presence within transport stream packets.

30. The method of claim 29, wherein if it is determined that adaptation field is present, then parsing the adaptation field and collecting information regarding emergency messages.

31. The method of claim 30, further comprising discovering and receiving an emergency message if not present within the adaptation field.

32. The method of claim 18, further comprising emergency alert triggering with a ULE extension header.

33. The method of claim 29, further comprising monitoring the presence of a ULE extension header.

34. The method of claim 18, further comprising emergency alert triggering with an IPv6 extension header.

35. The method of claim 34, further comprising monitoring the presence of an IPv6 extension header.

36. An apparatus comprising:
means for transmitting a non-emergency wireless service from a network server to a wireless device via a network; and
means for transmitting an emergency message from the emergency information server to the wireless device via the network, the emergency message corresponding to the emergency alert.

37. A wireless device adapted to receive a non-emergency wireless service via a network, the wireless device adapted to receive an emergency message from an emergency information server, the emergency message corresponding to an emergency alert.
